(19) United States
(12) Patent Application Publication
(10) Pub. No.: US 2026/0017875 A1
(43) Pub. Date: Jan. 15, 2026

(54) SIMULATION OF VIEWPOINT CAPTURE FROM ENVIRONMENT RENDERED WITH GROUND TRUTH HEURISTICS

(71) Applicant: Tesla, Inc., Austin, TX (US)

(72) Inventors: Charles HENDEN, Austin, TX (US); Matthew WILSON, Austin, TX (US); Uday CHADHA, Austin, TX (US); Artem BRIZITSKIY, Austin, TX (US); Michael EIZENBERG, Austin, TX (US); Prateek VISHAL, Austin, TX (US); David ABFALL, Austin, TX (US); Michael HOSTICKA, Austin, TX (US)

(73) Assignee: Tesla, Inc., Austin, TX (US)

(21) Appl. No.: 19/115,724

(22) PCT Filed: Sep. 29, 2023
(86) PCT No.: PCT/US2023/075631

§ 371 Date: Mar. 26, 2025

Related U.S. Application Data
(60) Provisional application No. 63/377,954, filed on Sep. 30, 2022.

(51) Int. Cl. G06T 15/20; G06T 7/11; G06T 17/00; G06T 19/20

(52) U.S. Cl. CPC G06T 15/20; G06T 7/11; G06T 17/00; G06T 19/20; G06T 2207/20081; G06T 2219/2024

(57) ABSTRACT

Aspects of this technical solution can generate, according to one or more first environment metrics, a three-dimensional (3D) model including a first surface corresponding to one or more physical ways through a physical environment, the one or more first environment metrics indicative of boundaries of the one or more physical ways, generate, according to one or more second environment metrics, one or more geometric two-dimensional (2D) objects on the first surface, the second environment metrics indicative of the one or more physical ways, identify, according to one or more viewpoint metrics indicative of cameras of a physical object configured to move along the one or more physical ways, one or more viewpoints oriented to capture corresponding portions of the 3D model, and render, from the one or more corresponding portions of the 3D model, one or more 2D images each corresponding to respective ones of the viewpoints.

### CROSS-REFERENCE TO RELATED PATENT APPLICATIONS

The present application claims priority to U.S. Provisional Application No. 63/377,954, filed Sep. 30, 2022, which is incorporated herein by reference in its entirety for all purposes.

### TECHNICAL FIELD

The present implementations relate generally to computer rendering, including but not limited to the simulation of viewpoint capture from an environment rendered with ground truth heuristics.

### BACKGROUND

Consumers increasingly demand mobile systems that can more accurately navigate their surroundings. Mobile systems can require a significant amount of reliable input from the real world to learn to accurately navigate their surroundings. The training of mobile systems to accurately navigate their surroundings is time-consuming and requires a significant amount of input corresponding to a wide variety of conditions. However, the volume of such input required by many mobile systems exceeds the amount of input that can be effectively obtained from the real world. For example, input for a particular real world location that exists in a tropical locale cannot be obtained in snowy or blizzard conditions.

### SUMMARY

This technical solution is directed at least to capturing simulated sensor data from a virtual environment corresponding to a physical environment. For example, a computing system can generate a three-dimensional model corresponding to one or more physical aspects of one or more physical environments in the real world. For example, the computing system can obtain one or more input models each corresponding to boundaries or shapes of areas measured from “ground-truth” of a physical environment having similar characteristics (e.g., roadways, medians). The computing system can generate a virtual environment corresponding to those aspects. The computing system can capture one or more viewpoints within the virtual environment corresponding to the movement of an autonomous object in a physical environment corresponding to the virtual environment. For example, viewpoints can correspond to respective cameras each having a particular orientation with respect to the autonomous object and can move in the virtual environment according to a position or orientation of the autonomous object. The computing system can also modify one or more aspects of the virtual environment, to create variations of the virtual environment that each correspond to the ground-truth roadway of the physical environment, but have not or cannot be captured by measurement or imaging of the physical environment. Thus, the computing system can create many virtual instances of a physical environment and create many simulated viewpoints corresponding to the many virtual instances of a physical environment, which can provide a technical improvement at least to generate a quantity of simulated viewpoints that exceeds the quantity available in the real world and a quantity that can be drawn manually. For example, a computing system can provide at least a technical improvement to allow autonomous objects that can more accurately navigate the real world. Thus, embodiments herein provide a technical solution for simulation of viewpoint captured from an environment rendered with ground truth heuristics.

In one embodiment, a system can include a memory and one or more processors. The system can retrieve a camera feed of an ego object navigating within a physical environment. The system can generate based on the camera feed, according to one or more first environment metrics, a three-dimensional (3D) model can include a first surface corresponding to one or more physical ways through the physical environment, the one or more first environment metrics indicative of boundaries of the one or more physical ways. The system can generate, according to one or more second environment metrics, one or more geometric two-dimensional (2D) objects on the first surface, the second environment metrics indicative of the one or more physical ways. The system can identify, according to one or more viewpoint metrics indicative of cameras of a physical object configured to move along the one or more physical ways, one or more viewpoints oriented to capture corresponding portions of the 3D model. The system can render, from the one or more corresponding portions of the 3D model of the physical environment, one or more simulated environment 2D images each corresponding to respective ones of the viewpoints. The system can train an artificial intelligence model in accordance with the camera feed and the one or more simulated environment 2D images.

The system can modify, according to one or more third environment metrics, a portion of the first surface corresponding to a portion of a physical way among the physical ways, the one or more third environment metrics indicative of a condition of the physical way.

The system can modify, according to one or more third environment metrics, a topology of the portion of the first surface.

The system can modify, according to one or more third environment metrics, an opacity of at least a portion of a geometric 2D object among the geometric 2D objects, the geometric 2D object located at the portion of the first surface.

The system can generate, according to a localization heuristic indicative of a type of physical objects in the physical environment, one or more 3D objects that satisfy the localization heuristic at one or more corresponding positions in a second surface of the 3D model excluding the first surface.

The system can include the type of physical objects corresponding to at least one of a type of geography, a type of climate, or a type of architecture.

The system can generate, according to an environment heuristic indicative of an atmospheric condition, indicative of weather in the physical environment, one or more 3D objects that satisfy the environment heuristic at one or more corresponding positions in the 3D model.

The system can segment, according to a block heuristic indicative of an amount of computational resources, a region model into a plurality of region segments, the region model indicative of a physical region can include the physical environment, and the region segments each corresponding to a respective portion of the region model, the 3D model corresponding to a region segment among the region segments.

The system can execute, by a first computation resource, a first subset of the region segments. The system can execute, by a second computation resource and concurrently with the execution by the first computation resource, a second subset of the region segments.

In another embodiment, a method can include retrieving a camera feed of an ego object navigating within a physical environment. The method can include generating, according to one or more first environment metrics, a three-dimensional (3D) model can include a first surface corresponding to one or more physical ways through a physical environment, the one or more first environment metrics indicative of boundaries of the one or more physical ways. The method can include generating, according to one or more second environment metrics based on the camera feed, one or more geometric two-dimensional (2D) objects on the first surface, the second environment metrics indicative of the one or more physical ways. The method can include identifying, according to one or more viewpoint metrics indicative of cameras of a physical object configured to move along the one or more physical ways, one or more viewpoints oriented to capture corresponding portions of the 3D model. The method can include rendering, from the one or more corresponding portions of the 3D model of the physical environment, one or more 2D images each corresponding to respective ones of the viewpoints. The method can include training an artificial intelligence model in accordance with the camera feed and the one or more simulated environment 2D images.

The method can include modifying, according to one or more third environment metrics, a portion of the first surface corresponding to a portion of a physical way among the physical ways, the one or more third environment metrics indicative of a condition of the physical way.

The method can include modifying, according to one or more third environment metrics, a topology of the portion of the first surface.

The method can include modifying, according to one or more third environment metrics, an opacity of at least a portion of a geometric 2D object among the geometric 2D objects, the geometric 2D object located at the portion of the first surface.

The method can include generating, according to a localization heuristic indicative of a type of physical objects in the physical environment, one or more 3D objects that satisfy the localization heuristic at one or more corresponding positions in a second surface of the 3D model excluding the first surface.

The method can include the type of physical objects corresponding to at least one of a type of geography, a type of climate, or a type of architecture.

The method can include generating, according to an environment heuristic indicative of an atmospheric condition, indicative of weather in the physical environment, one or more 3D objects that satisfy the environment heuristic at one or more corresponding positions in the 3D model.

The method can include segmenting, according to a block heuristic indicative of an amount of computational resources, a region model into a plurality of region segments, the region model indicative of a physical region can include the physical environment, and the region segments each corresponding to a respective portion of the region model, the 3D model corresponding to a region segment among the region segments.

The method can include executing, by a first computation resource, a first subset of the region segments. The method can include executing, by a second computation resource and concurrently with the execution by the first computation resource, a second subset of the region segments.

In yet another embodiment, a non-transitory computer readable medium may include one or more instructions stored thereon and executable by a processor. The processor can retrieve a camera feed of an ego object navigating within a physical environment. The processor can generate, according to one or more first environment metrics, a three-dimensional (3D) model can include a first surface corresponding to one or more physical ways through a physical environment, the one or more first environment metrics indicative of boundaries of the one or more physical ways. The processor can generate, according to one or more second environment metrics, one or more geometric two-dimensional (2D) objects on the first surface, the second environment metrics indicative of the one or more physical ways. The processor can identify, according to one or more viewpoint metrics indicative of cameras of a physical object configured to move along the one or more physical ways, one or more viewpoints oriented to capture corresponding portions of the 3D model. The processor can render, from the one or more corresponding portions of the 3D model of the physical environment, one or more simulated environment 2D images each corresponding to respective ones of the viewpoints. The processor can train an artificial intelligence model in accordance with the camera feed and the one or more simulated environment 2D images.

The computer readable medium can include one or more instructions executable by a processor. The processor can modify, according to one or more third environment metrics, a portion of the first surface corresponding to a portion of a physical way among the physical ways, the one or more third environment metrics indicative of a condition of the physical way.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1A illustrates components of an AI-enabled visual data analysis system, according to an embodiment.

FIG. 1B illustrates various sensors associated with an ego, according to an embodiment.

FIG. 1C illustrates the components of a vehicle, according to an embodiment.

FIG. 2 illustrates a flow diagram of simulation of viewpoint capture from an environment rendered with ground truth heuristics, according to an embodiment.

FIG. 3 illustrates a system architecture, according to an embodiment.

FIG. 4 illustrates a ground truth visualization, according to an embodiment.

FIG. 5 illustrates a road visualization, according to an embodiment.

FIG. 6 illustrates a road surface visualization, according to an embodiment.

FIG. 7A illustrates a road line visualization, according to an embodiment.

FIG. 7B illustrates a road line visualization, according to an embodiment.

FIG. 8A illustrates an external surface visualization, according to an embodiment.

FIG. 8B illustrates a populated external surface visualization, according to an embodiment.

FIG. 9A illustrates a traffic object visualization, according to an embodiment.

FIG. 9B illustrates a populated traffic object visualization, according to an embodiment.

FIG. 10 illustrates a populated traffic environment, according to an embodiment.

FIG. 11A illustrates a visualization with a modified environment scenario, according to an embodiment.

FIG. 11B illustrates a visualization with a modified environment scenario, according to an embodiment.

FIG. 12 illustrates rendered video objects, according to an embodiment.

FIG. 13 illustrates a segmented geography model, according to an embodiment.

FIG. 14 illustrates a segmentation architecture, according to an embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

For example, a system can render multiple distinct three-dimensional environments that have one or more aspects corresponding to the physical features of a physical environment. For example, the system can obtain ground-truth data models corresponding to one or more aspects of a physical environment detected from that physical environment. For example, aspects of the physical environment can include, but are not limited to, boundaries between roadways and surrounding land, surface features of a roadway, surface markings of a roadway, traffic signs or lights at particular positions with respect to a roadway, and traffic patterns through a roadway.

The system can modify aspects of the virtual environment to generate many more instances than exist in a particular physical location or condition of a physical location. For example, the system can modify a virtual environment to modify particular roadway markings to change indications of traffic flow, change levels of wear on a roadway surface, levels of water on a roadway surface, roadway markings, or traffic signs, or change one more objects surrounding a roadway corresponding to weather, a biome or a level of urban density. The system can include dynamic objects that can be captured by one or more viewpoints. For example, dynamic objects can include dynamic traffic objects including traffic lights or gates. In another example, dynamic objects can include dynamic environment objects including trees, branches, traffic cones, or other obstructions in a roadway or that can affect traffic patterns or vehicles, pedestrians, or any combination thereof. Thus, this technical solution can provide at least a technical improvement to create numerous permutations of a real-world environment that would otherwise not be available and that could not be detected or drawn manually.

The system can allocate the generation of multiple portions of a physical region to achieve at least a technical improvement to create numerous permutations of a real-world environment that would otherwise not be available and that could not be detected or drawn manually. For example, the system can divide a large geographic region into a plurality of physical locations and allocate one or more instructions to render corresponding physical locations to one or more processors or processor cores. For example, the system can allocate various instructions to render various corresponding physical locations according to one or more aspects of the physical locations or one or more modifications to the one or more aspects.

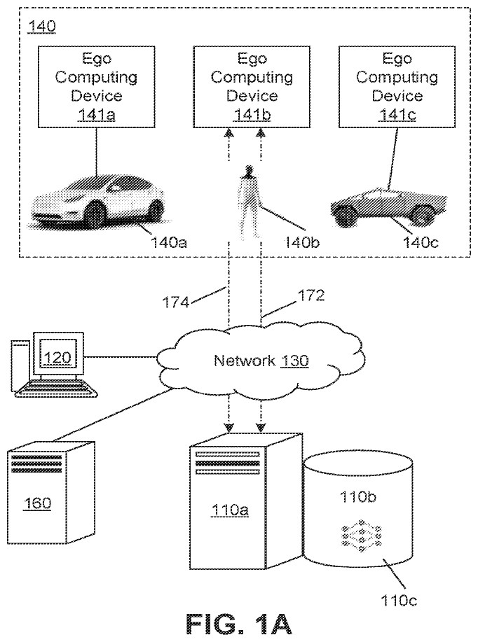

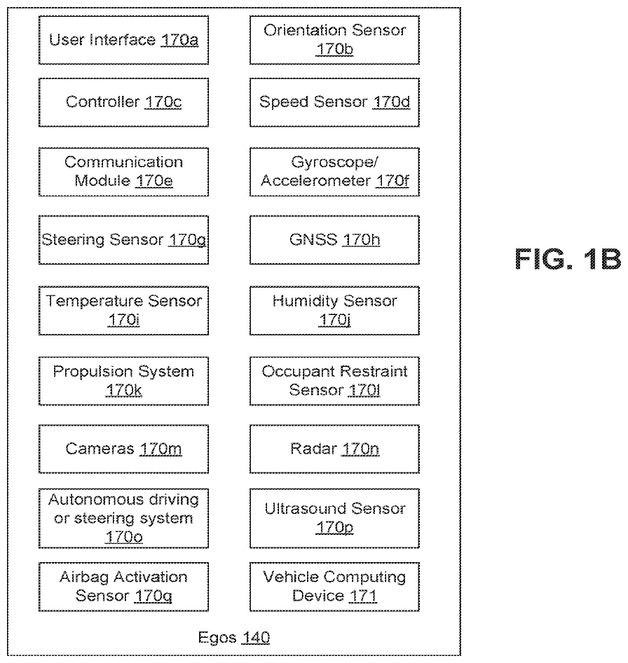

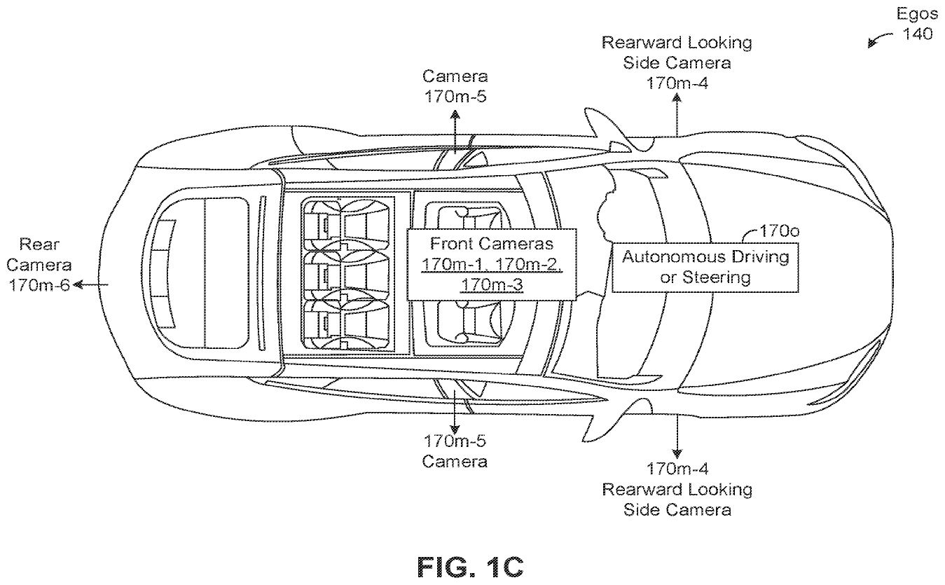

FIG. 1A is a non-limiting example of components of a system in which the methods and systems discussed herein can be implemented. For instance, an analytics server may train an artificial intelligence (AI) model and use the trained AI model to generate an occupancy dataset and/or map for one or more egos. FIG. 1A illustrates components of an AI-enabled visual data analysis system 100. The system 100 may include an analytics server 110a, a system database 110b, an administrator computing device 120, egos 140a-b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 miles, 100 feet) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-C illustrate block diagrams of sensors integrated within the egos 140, according to an embodiment. The number and position of each sensor discussed with respect to FIGS. 1B-C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 1701 may monitor seatbelt detection and locking/unlocking assemblies, as well as other passenger restraint subsystems. The occupant restraint sensor 1701 may include various environmental and/or status sensors, actuators, and/or other devices facilitating the operation of safety mechanisms associated with the operation of the egos 140. For example, occupant restraint sensor 1701 may be configured to receive motion and/or status data from other sensors depicted in FIG. 1B. The occupant restraint sensor 1701 may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior-or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 1700 configured to use data collected via various sensors (e.g., radar 170n, speed sensor 170d, and/or ultrasound sensors 170p) to autonomously navigate the ego 140.

Therefore, autonomous driving or steering system 170o may analyze various data collected by one or more sensors described herein to identify driving data. For instance, autonomous driving or steering system 170o may calculate a risk of forward collision based on the speed of the ego 140 and its distance to another vehicle on the road. The autonomous driving or steering system 170o may also determine whether the driver is touching the steering wheel. The autonomous driving or steering system 170o may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how the AI model(s) 110c can be trained, the analytics server 110a may collect data from simulated egos 140 to train the AI model(s) 110c. Before executing the AI model(s) 110c to generate/predict a training dataset, the analytics server 110a may generate training data. The training allows the AI model(s) 110c to ingest data from one or more simulated cameras of one or more simulated egos 140 (without the need to receive radar data). The operation described in this example may be executed by any number of computing devices operating in the distributed computing system described in FIGS. 1A and 1B.

To train the AI model(s) 110c, the analytics server 110a may first employ one or more of the egos 140 to drive a particular simulated route in a virtual environment. While driving, the egos 140 may use one or more of their simulated sensors (including one or more simulated cameras) to generate navigation session data. For instance, the one or more of the simulated egos 140 equipped with various simulated sensors can navigate the designated route in the virtual environment. As the one or more of the egos 140 traverse the terrain, their simulated sensors may capture continuous (or periodic) data of their surroundings. The simulated sensors may capture visual information of the one or more egos' 140 surroundings.

The analytics server 110a may generate a training dataset using data collected from the egos 140 (e.g., simulated camera feed received from the egos 140). The training dataset may indicate the videos from one or more simulated cameras corresponding to viewpoints from the simulated egos 140 within the surroundings of the one or more of the egos 140.

In operation, as the one or more egos 140 navigate, their sensors collect data and transmit the data to the analytics server 110a, as depicted in the data stream 172.

In some embodiments, the one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos' 140 surroundings are included within the second dataset.

In operation, as the one or more egos 140 navigate, their cameras collect data and transmit the data to the analytics server 110a, as depicted in the data stream 172. For instance, the ego computing devices 141 may transmit image data to the analytics server 110a using the data stream

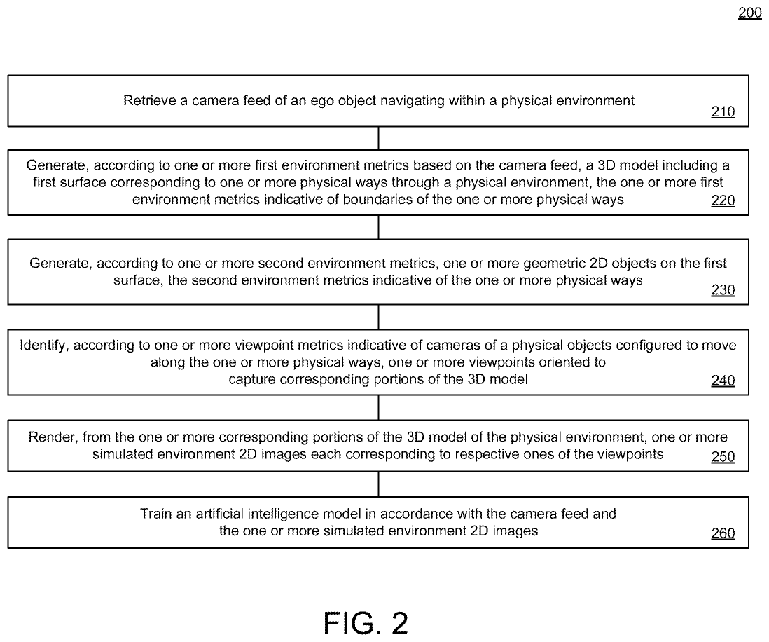

FIG. 2 depicts an example method of simulation of viewpoint capture from an environment rendered with ground truth heuristics according to this disclosure. At least one of the systems or vehicles of any of FIGS. 1A-C can perform method 200.

At 210, the method 200 can retrieve a camera feed of an ego object navigating within a physical environment. For example, the camera feed can correspond to a series of images or a video captured from a virtual environment by a viewpoint within the virtual environment. For example, the ego object can correspond to a simulated ego object traveling within a virtual environment.

At 220, the method 200 can generate, according to one or more first environment metrics, a 3D model including a first surface corresponding to one or more physical ways through a physical environment, the one or more first environment metrics indicative of boundaries of the one or more physical ways. For example, the boundaries can correspond to one or more points, vectors, planes, or volumes that define edges and surfaces topology of one or more roadway surfaces. For example, the boundaries can be obtained or generated from detection of surface topology of a physical environment via one or more sensors. For example, the boundaries can define a road and curb mesh.

At 230, the method 200 can generate, according to one or more second environment metrics, one or more geometric 2D objects on the first surface, and the second environment metrics indicative of the one or more physical ways. For example, the 2D objects can correspond to one or more points, vectors, planes, textures, images, or patterns that define two-dimensional objects on one or more roadway surfaces. For example, the 2D objects can be indicative of lane markings, directions markings, or any combination thereof. For example, the 2D objects can be obtained or generated from detection of surface imagery of a physical environment via one or more sensors. For example, the 2D objects can define lane paint decals and directional road markings.

At 240, the method 200 can identify, according to one or more viewpoint metrics indicative of cameras of a physical object configured to move along the one or more physical ways, one or more viewpoints oriented to capture corresponding portions of the 3D model. For example, the cameras of a physical object can be simulated viewpoints in a virtual environment and capture rendered video objects. Viewpoints can include a front view, a right-front view, a right-rear view, a left-front view, and a left-rear view. Each of the viewpoints can correspond to 2D images or 2D video captured by a simulated ego vehicle traveling through a virtual environment.

At 250, the method 200 can render, from the one or more corresponding portions of the 3D model, one or more 2D images each corresponding to a respective viewpoint of the one or more viewpoints. For example, the method 200 can render 2D video by capturing images from a simulated viewpoint over time.

At 260, the method 200 can train an artificial intelligence model in accordance with the camera feed and the one or more simulated environment 2D images. For example, the AI model 110c can be used for a training scenario. For example, a system can obtain one or more models generated from measurement of boundaries of various roads, medians, crosswalks, sidewalks, bike lanes, or any other features of an outdoor built environment. The system can add textures and objects to the roadway and the surrounding spaces to generate a visualization of the intersection as it appears in the real world. The system can change, remove or add street signs, road surfaces, street markings, weather conditions, road obstructions, traffic markers, or any combination thereof, to create multitudes of variations of the intersection, while maintaining the measured properties of the intersection as it appears in the real world. In varying the environment, the system can change the time of day, the weather, or other conditions. This way, the system can provide at least a technical improvement to provide a multitude of variations of a real world location to provide training data that far exceeds the volume and type that can be obtained by manual processes in the real world, including at least because many of the environments that can be generated by this technical solution do not and cannot exist in the real world.

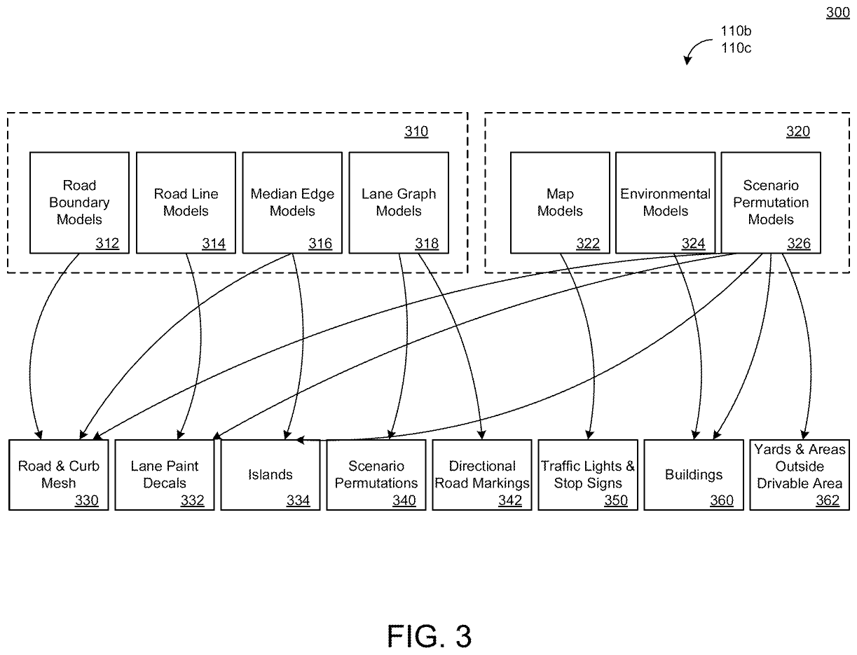

FIG. 3 depicts an example system architecture according to this disclosure. As illustrated by way of example in FIG. 3, a system architecture 300 can include at least ground truth models 310, and geospatial models 320, each variously indicative of, but not limited to, a road and curb mesh 330, lane paint decals 332, islands 334, scenario permutations 340, directional road markings 342, traffic lights and stop signs 350, buildings 360, and a yards and areas outside drivable area 362. For example, the AI model 110c can have or be configured according to the system architecture 300.

The ground truth models 310 can include data structures indicative of physical aspects of a physical environment in the real world. For example, the ground truth models 310 can correspond to spatial or geographic identifiers in a coordinate space. For example, the ground truth models 310 can correspond to one or more collections of one or more spatial elements including points, vectors, planes, volumes, textures, images, patterns, or any combination thereof. The spatial elements can be defined or determined, for example, according to a coordinate system that is indicative or can be transformed to be indicative of a physical environment. For example, the spatial elements can correspond to one or more of latitude, longitude, or altitude, or can be defined in relative terms to other spatial elements. The ground truth models 310 can correspond to a collection of models each indicative of distinct aspects of a physical environment. The ground truth models 310 can include road boundary models 312, road line models 314, median edge models 316, and lane graph models 318. For example, the ground truth models 310 can be derived from measurements of a physical environment in the real world.

The road boundary models 312 can indicate structure of one or more exterior edges of one or more roadways in a physical environment. For example, the road boundary models 312 can correspond to one or more points, vectors, planes, or volumes that define edges and surfaces topology of one or more roadway surfaces. For example, the road boundary models 312 can be obtained or generated from detection of surface topology of a physical environment via one or more sensors. For example, the road boundary models can define the road and curb mesh 330. The road line models 314 can indicate structure of one or more markings on one or more roadways in a physical environment. For example, the road line models 314 can correspond to one or more points, vectors, planes, textures, images, or patterns that define two-dimensional objects on one or more roadway surfaces. For example, the road line models 314 can be indicative of lane markings, directions markings, or any combination thereof. For example, the road line models 314 can be obtained or generated from detection of surface imagery of a physical environment via one or more sensors. For example, the road line models 314 can define the lane paint decals 332 and the directional road markings 342.

The median edge models 316 can indicate structure of one or more interior edges of one or more roadways in a physical environment. For example, the road boundary models 312 or median edge models 316 can correspond to one or more points, vectors, planes, or volumes that define edges and surfaces topology of one or more roadway surfaces that lie at least partially within one or more of the road boundary models 312. For example, the median edge models 316 can be obtained or generated from detection of surface topology of a physical environment via one or more sensors. For example, the median edge models 316 can define the islands 334 that correspond to non-drivable areas surrounded by roadways.

The lane graph models 318 can indicate patterns of movement of one or more moveable objects in roadways in a physical environment. For example, the lane graph models 318 can correspond to one or more points, vectors, planes, or volumes that define pathways along one or more roadway surfaces according to one or more markings of the road line models 314. For example, the road boundary models 312 can be obtained or generated from detection of surface topology of a physical environment via one or more sensors.

The geospatial models 320 can include data structures indicative of physical aspects of a physical environment in the real world that are distinct from the ground truth models 310. For example, the geospatial models 320 can correspond at least partially in one or more of structure and operation to the ground truth models 310. The geospatial models 320 can be obtained from sensors extrinsic to or distinct from sensors to detect the ground truth models 310. For example, sensors of a vehicle traversing one or more roadways can detect data to generate the ground truth models 310, and sensors of satellites or data corresponding to geographic information systems (GIS) can generate the geospatial models 320. The geospatial models 320 can include map models 322, environmental models 324, and scenario permutation models 326.

The map models 322 can indicate structure of one or more objects along one or more roadways in a physical environment. For example, the road boundary models 312 can correspond to one or more points, vectors, planes, or volumes that define shapes and locations of one or more objects distinct from roadway surfaces. For example, the map models 322 can be obtained or generated from detection of imagery of a physical environment above or surrounding a roadway via one or more sensors. For example, the map models 322 can define one or more of the traffic lights and stop signs data 350.

The environmental models 324 can indicate structure of one or more objects along one or more roadways in a physical environment. For example, the road boundary models 312 can correspond to one or more points, vectors, planes, or volumes that define shapes and locations of one or more objects distinct from roadway surfaces. For example, the environmental models 324 can be obtained or generated from detection of imagery of a physical environment above or surrounding a roadway via one or more sensors.

The scenario permutation models 326 can include one or more instructions for modification of one or more of the ground truth models 310 or the geospatial models 320 that correspond to a particular 3D model of a physical environment. For example, the scenario permutation model can include one or more instructions to populate or transform one or more environmental models 324 into one or more of the scenario permutations 340 according to one or more environmental heuristics. For example, an environment heuristic can correspond to weather, a biome or a level of urban density. For example, the scenario permutation models 326 can modify or replace one or more of the buildings 360 and the yards and areas outside drivable area 362 in accordance with the environmental heuristics.

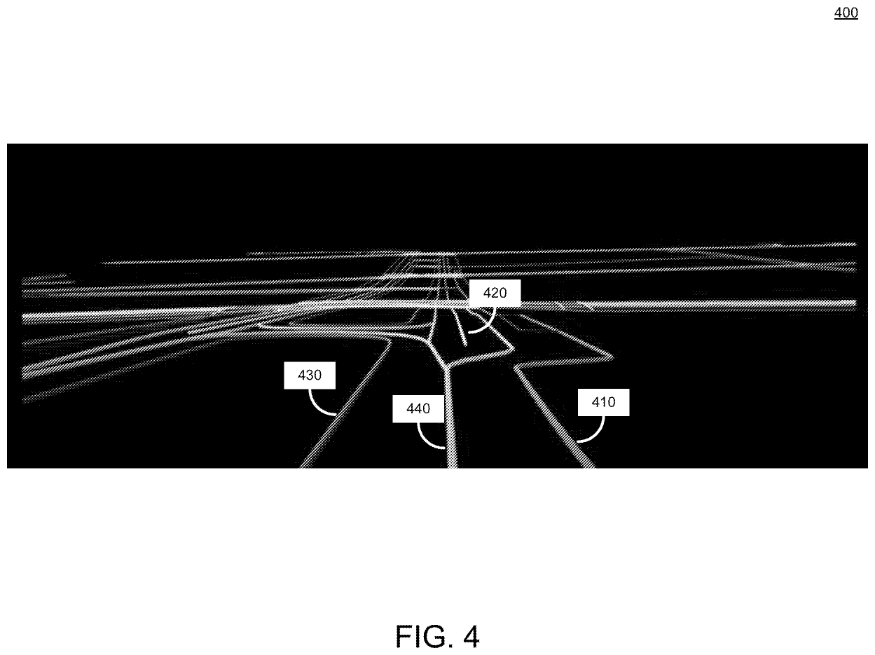

FIG. 4 depicts an example ground truth visualization according to this disclosure. As illustrated by way of example in FIG. 4, a ground truth model 400 can include at least a road boundary model 410, a road line model 420, a median edge model 430, and a lane graph model 440. The ground truth model 400 can correspond to a 3D model including at least one of the ground truth models 310 or the geospatial models 320 but is not limited thereto.

The road boundary model 410 can correspond to a rendering or instantiation of a road boundary model among the road boundary models 312 that indicate a road 330. For example, the road boundary model 410 can include an outline indicative of one or more intersecting roadways. The road line model 420 can correspond to a rendering or instantiation of a road line model among the road line models 314 that indicates one or more of the lane paint decals 332. For example, the road line model 420 can include an outline indicative of one or more markings on corresponding surfaces of one or more intersecting roadways. The median edge model 430 can correspond to a rendering or instantiation of a median edge model for an island among the median edge models 316 that indicate one or more of the islands 334. For example, the median edge model 430 can include an outline indicative of one or more islands at least partially within one or more intersecting roadways of the road boundary model 410. The lane graph model 440 can correspond to a rendering or instantiation of a path of movement among the lane graph models 318 that indicates one or more paths of movement of corresponding vehicles, pedestrians, or any combination thereof. For example, the lane graph model 440 can include a pathway for one or more vehicles along one or more intersecting roadways. For example, the lane graph model 440 can include a pathway for one or more pedestrians across one or more intersecting roadways.

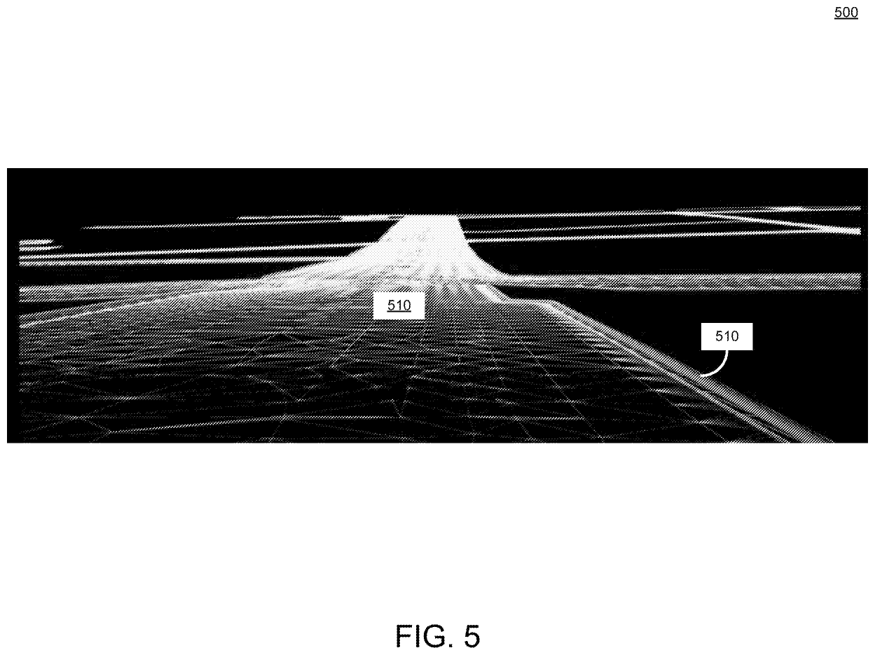

FIG. 5 depicts an example road visualization according to this disclosure. As illustrated by way of example in FIG. 5, a road model 500 can include at least a road topology model 510. The road topology model 510 can correspond to a rendering or instantiation of a surface topology of a road surface according to the road boundary model among the road boundary models 312 that indicates a curb mesh 330. For example, the road topology model 510 can include a mesh surface indicative of the surface elevation of one or more intersecting roadways at one or more corresponding points along the roadway. The road boundary model 520 can correspond at least partially in one or more of structure and operation to the road boundary model 410.

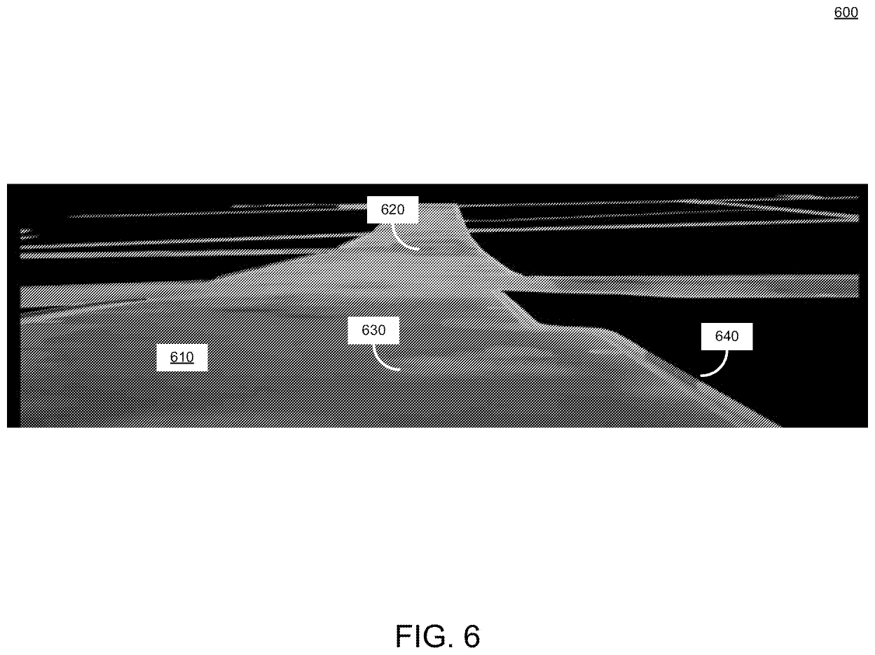

FIG. 6 depicts an example road surface visualization according to this disclosure. As illustrated by way of example in FIG. 6, a road surface model 600 can include at least a textured road topology model 610. The textured road topology model 610 can correspond to the road topology model 510 having a rendered road surface indicative of a road surface at a physical location. For example, the textured road topology model 610 can include a road surface having a texture corresponding to or indicative of asphalt. For example, the textured road topology model 610 can include one or more surface features or can have one or more surface features present thereon. The textured road topology model 610 can include a topology feature 620, and an environmental feature 630. The topology feature 620 can correspond to a portion of the textured road topology model 610 having a topology indicative of a road feature having a shape distinct from a plane corresponding to the road topology model 510 surrounding the road feature. For example, a road feature can correspond to a pothole or a speed bump but is not limited thereto. The environmental feature 630 can correspond to a portion of the textured road topology model 610 having an environmental property distinct from a road property corresponding to the road topology model 510 surrounding the road feature. For example, an environmental property can correspond to a puddle having a first reflectivity greater than a second reflectivity of the asphalt of the textured road topology model 610 but is not limited thereto. The road boundary model 640 can correspond at least partially in one or more of structure and operation to the road boundary model 410.

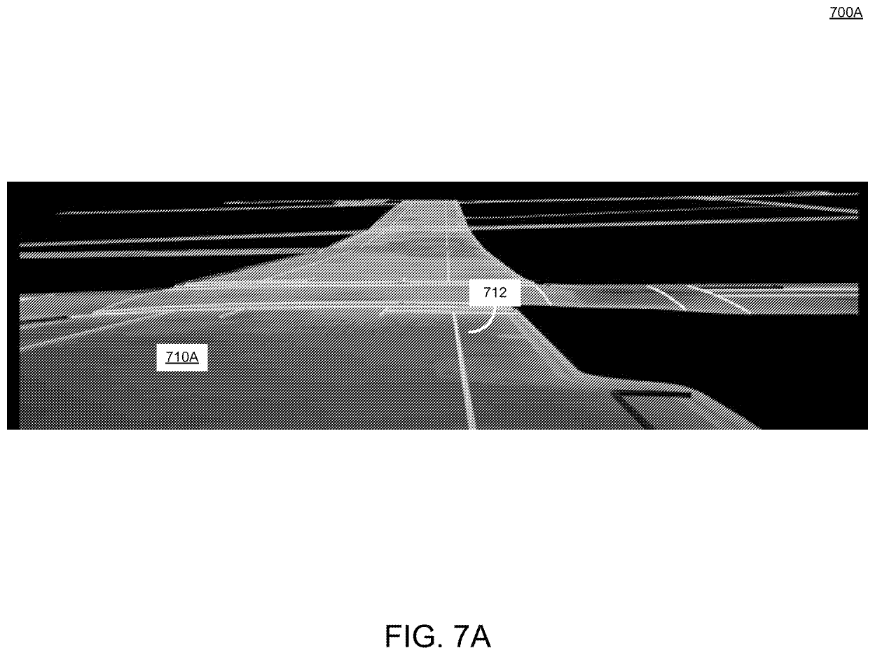

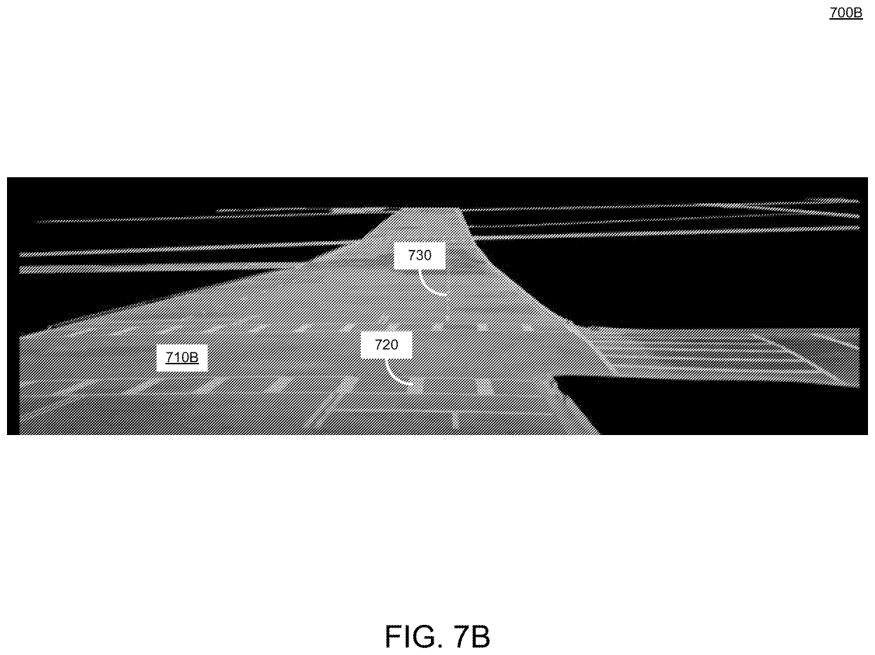

FIG. 7A depicts an example road line visualization according to this disclosure. As illustrated by way of example in FIG. 7A, a road line model 700A can include at least a textured road topology model 710A. The textured road topology model 710A can correspond at least partially in one or more of structure and operation to textured road topology model 610. The road line model 700A can include the road line model 712 and the textured road topology model 610, and can correspond to a state of a 3D model before rendering of one or more of the lane paint decals 332 corresponding to the road line model 712. The road line model 712 can correspond at least partially in one or more of structure and operation to the road line model 420.

FIG. 7B depicts an example road line visualization according to this disclosure. As illustrated by way of example in FIG. 7B, a road line model 700B can include at least a line-mapped road surface 710B. The line-mapped road surface 710B can correspond at least partially in one or more of structure and operation to textured road topology model 710A and can include one or more of the lane paint decals 332 corresponding to the road line model 420. The road line model 700B can thus correspond to a state of the 3D model after rendering of one or more of the lane paint decals 332 corresponding to the road line model 420.

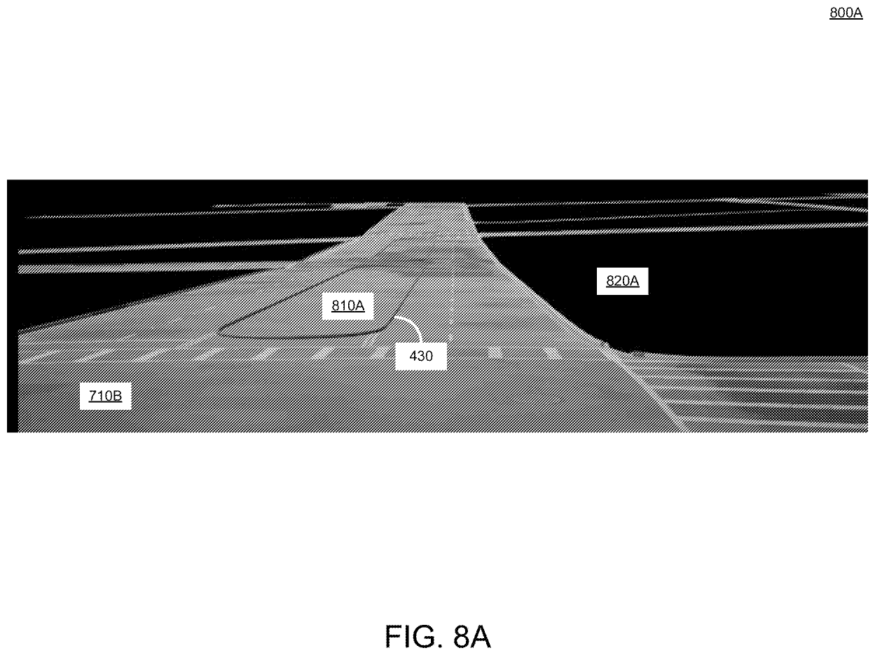

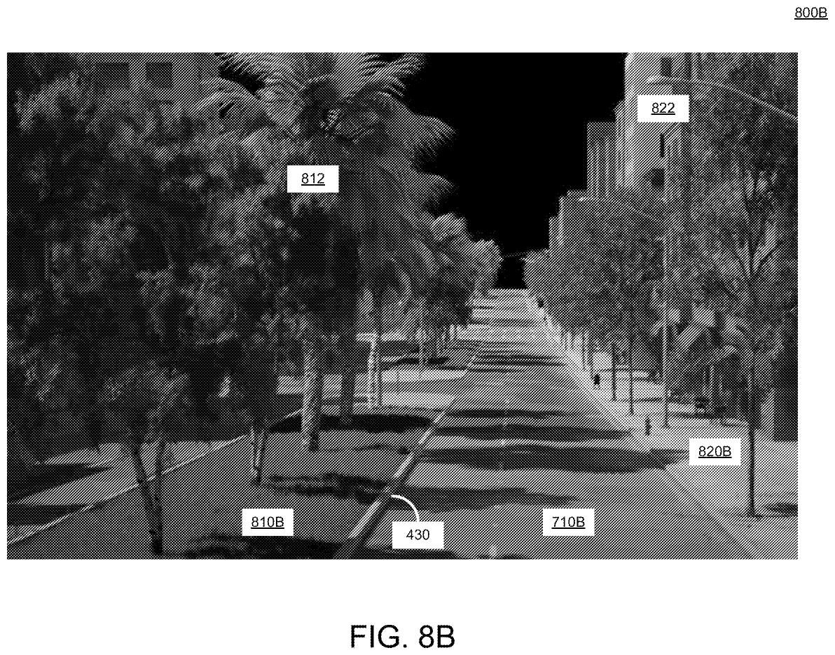

FIG. 8A depicts an example external surface visualization according to this disclosure. As illustrated by way of example in FIG. 8A, an external surface model 800A can include at least a line-mapped road surface 802, a median edge model 804, a median region 810A, and a block region 820A. The median region 810A can correspond to a portion of a physical environment corresponding to one or more islands 334. The median region 810A can be at least partially enclosed by at least a portion of the road line model 420. The block region 820A can correspond to a portion of a physical environment corresponding to one or more outside a drivable area 362. The block region 820A can be at least partially outside at least a portion of the road line model 420. For example, the block region 820A can correspond to portions of a physical environment indicative of city blocks outside of public rights of way, including but not limited to roadways. The line-mapped road surface 802 can correspond at least partially in one or more of structure and operation to the line-mapped road surface 710B. The median edge model 804 can correspond at least partially in one or more of structure and operation to the median edge model 430.

FIG. 8B depicts an example populated external surface visualization according to this disclosure. As illustrated by way of example in FIG. 8B, a populated external surface model 800B can include at least a populated median region 810B, and a populated block region 820B.

The populated median region 810B can correspond at least partially in one or more of structure and operation to the median region 810A and can include one or more objects disposed at least partially within the one or more islands 334 corresponding to the median region 810A and the populated median region 810B. For example, the populated median region 810B can correspond to one or more islands 334 having one or more tree objects thereon and including a grass surface having a color and texture distinct from that of the road surface 710B. For example, the tree objects can include dynamic components that can interact with a 3D environment according to one or more of the scenario permutations 340. For example, the tree objects can include branch objects or leaf objects that cover at least a portion of the populated median region 810B or the road surface 710B. The populated block region 820B can correspond at least partially in one or more of structure and operation to the block region 820A and can include one or more objects disposed at least partially within the populated block region 820B. For example, the populated block region 820B can correspond to one or more of the areas outside a drivable area 330 having one or more building objects or tree objects thereon and including a sidewalk surface having a color and texture distinct from that of the road surface 710B. For example, one or more objects of the populated median region 810B and the populated block region 820B can be modified or substituted according to one or more of the scenario permutations 340.

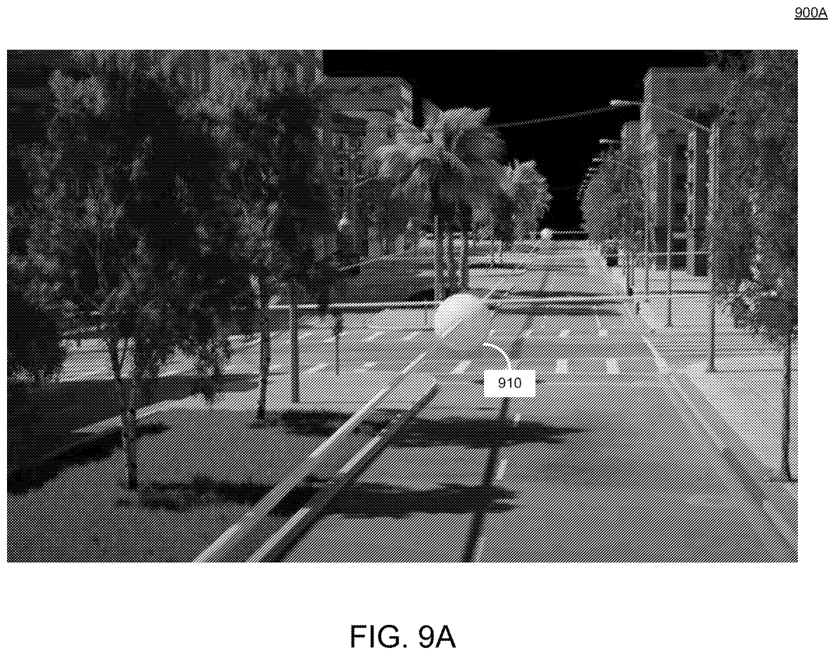

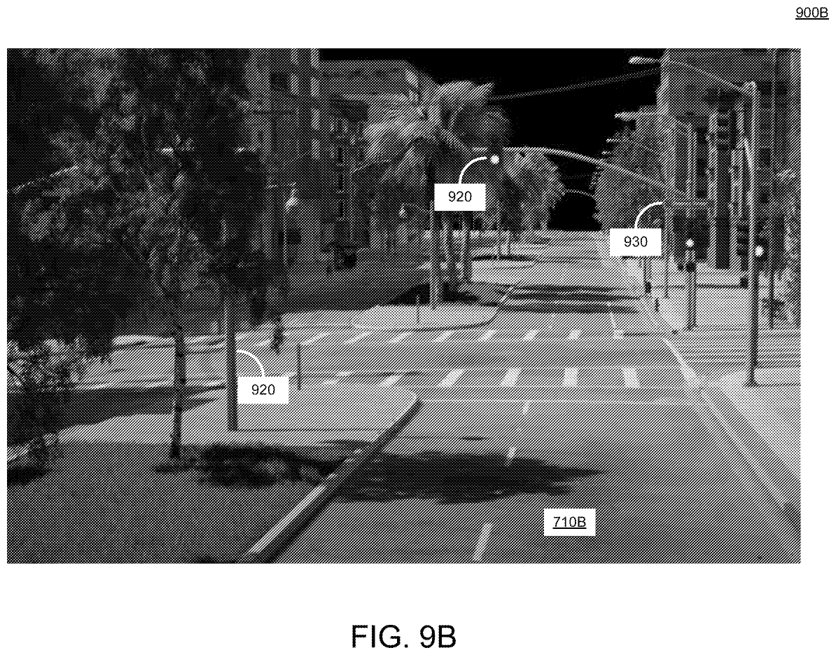

FIG. 9A depicts an example traffic object model according to this disclosure. As illustrated by way of example in FIG. 9A, a traffic object model 900A can include at least a line-mapped road surface 902, a map data model 910. The map data model 910 can correspond at least partially in one or more of structure and operation to the map models 322. For example, the map data model 910 can correspond to a map data model among the map models 332 for the road surface 710B. The map data model 910 can include one or more indicators corresponding to one or more traffic objects corresponding to a particular physical location. For example, the map data model 910 can include location data for one or more traffic lights or stop signs 350. The line-mapped road surface 902 can correspond at least partially in one or more of structure and operation to the line-mapped road surface 802.

FIG. 9B depicts an example populated traffic object model according to this disclosure. As illustrated by way of example in FIG. 9B, a populated traffic object model 900B can include at least a dynamic traffic object 920, and a static traffic object 930. The dynamic traffic object 920 can correspond to an object having multiple states that can be rendered in 3D model corresponding to a physical environment. For example, the dynamic traffic object 920 can correspond to a traffic light that can be rendered to indicate multiple states according to a three-light stoplight for vehicular traffic. For example, the dynamic traffic object 920 can correspond to a traffic light that can be rendered to indicate multiple states according to a multi-state lighted sign for pedestrian or cyclist traffic. The static traffic object 930 can correspond to an object having multiple states that can be rendered in 3D model corresponding to a physical environment. For example, the static traffic object 930 can correspond to a stop sign that can be rendered to a single state according to a stop sign texture. For example, the static traffic object 930 can correspond to a street sign that can be rendered to a single state according to a street sign texture and a location indicated by the map data model 910.

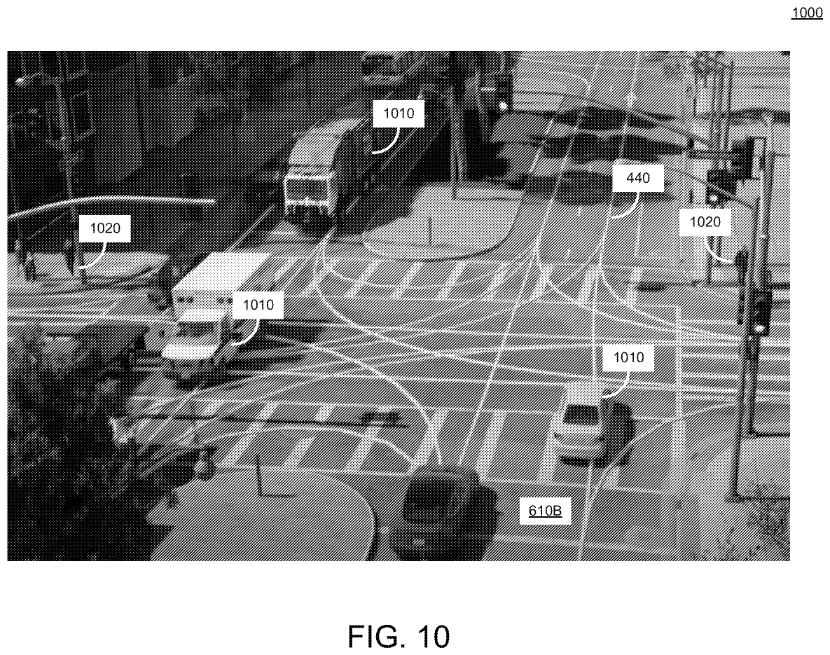

FIG. 10 depicts an example populated traffic environment according to this disclosure. As illustrated by way of example in FIG. 10, a populated traffic environment 1000 can include at least a line-mapped road surface 1002, a lane graph model 1004, roadway traffic objects 1010, and an intersecting traffic objects 1020. The roadway traffic objects 1010 can correspond to 3D objects that can move along one or more paths of the lane graph model 440 corresponding to the road surface 1002. For example, the roadway traffic objects 1010 can correspond to vehicles including automobiles, bicycles, motorcycles, trucks, or any combination thereof, but are not limited thereto. The intersecting traffic objects 1020 can correspond to 3D objects that can move along one or more paths of the lane graph model 440 corresponding to the road surface 1002. For example, the roadway traffic objects 1010 can correspond to vehicles including automobiles, bicycles, motorcycles, trucks, or any combination thereof, but not limited thereto. line-mapped road surface 1002 can correspond at least partially in one or more of structure and operation to the line-mapped road surface 710B. The lane graph model 1004 can correspond at least partially in one or more of structure and operation to the lane graph model 1004.

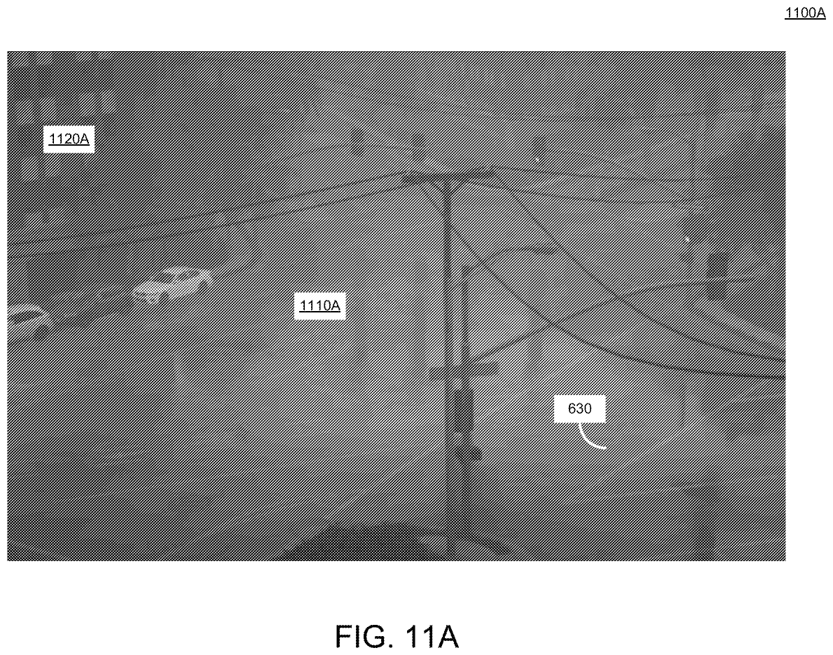

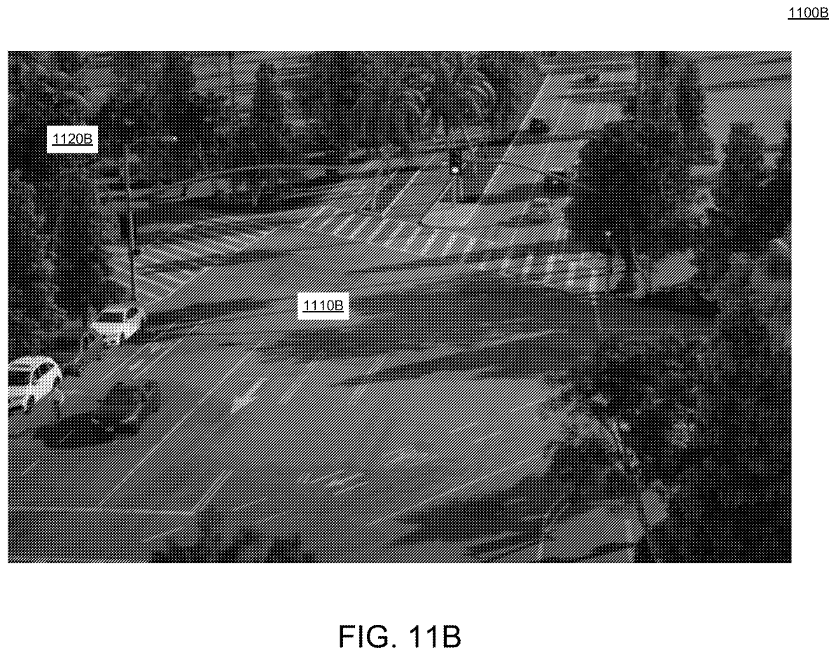

FIG. 11A depicts an example model with a modified environment scenario according to this disclosure. As illustrated by way of example in FIG. 11A, a model with a modified environment scenario 1100A can include at least a line-mapped road surface 1102, an environmental feature 1104, a modified weather environment 1110A, and a locale environment 1120A. The line-mapped road surface 1102 can correspond at least partially in one or more of structure and operation to the line-mapped road surface 710B. The environmental feature 1004 can correspond at least partially in one or more of structure and operation to the environmental feature 630.

The modified weather environment 1110A can correspond at least partially in one or more of structure and operation to the populated traffic environment 1000 and can include one or more visual properties corresponding to a weather condition that is distinct from the physical environment in the real world as captured by one or more sensors. For example, the modified weather environment 1110A can include modifications to the road surface 710B to include additional puddle objects, modifications to tree objects to include additional leaf objects or branch objects on the road surface 710B or can include one or more objects or filters corresponding to a lowered visibility distance within the populated traffic environment 1000. Thus, the modified weather environment 1110A can provide at least a technical improvement of eliminating or minimizing additional sensor capture of a physical environment in multiple weather states, while retaining accuracy of the model with respect to the corresponding physical environment in the real world, according to the ground truth models 310.

The locale environment 1120A can correspond at least partially in one or more of structure and operation to the populated traffic environment 1000 and can include one or more visual properties corresponding to a locale associated with the physical environment in the real world. For example, the locale environment 1120A can be linked with an urban environment and can be linked with a plurality of objects respectively linked with the urban environment. This plurality of objects can include, for example, models of buildings 360 of a predetermined size, height, or footprint. Thus, the locale environment 1120A can correspond to a locale or biome that corresponds to the physical environment in the real world as captured by one or more sensors.

FIG. 11B depicts an example model with a modified environment scenario according to this disclosure. As illustrated by way of example in FIG. 11B, a model with a modified environment scenario 1100B can include at least a weather environment 1110B, and a modified locale environment 1120B.

The weather environment 1110B can correspond at least partially in one or more of structure and operation to the populated traffic environment 1000 and can include one or more visual properties corresponding to a weather condition of the physical environment in the real world as captured by one or more sensors. For example, the weather environment 1110B can include the road surface 710B without puddle objects, leaf objects or branch objects on the road surface 710B, or objects or filters corresponding to a lowered visibility distance within the populated traffic environment 1000.

The modified locale environment 1120B can correspond at least partially in one or more of structure and operation to the populated traffic environment 1000 and can include one or more visual properties corresponding to a locale that is distinct from the physical environment in the real world. For example, the modified locale environment 1120B can be linked with a rural, environment, or tropical environment, and can be linked with a plurality of objects respectively linked with the corresponding environment. This plurality of objects can include, for example, models of buildings 360 of a predetermined size, height, or footprint. Thus, modified locale environment 1120B can correspond to a locale or biome that is distinct from the physical environment in the real world as captured by one or more sensors. Thus, the modified locale environment 1120B can provide at least a technical improvement of creating additional locations with distinct physical properties that do not exist in the real world, while retaining accuracy of the model with respect to the corresponding physical environment in the real world, according to the ground truth models 310.

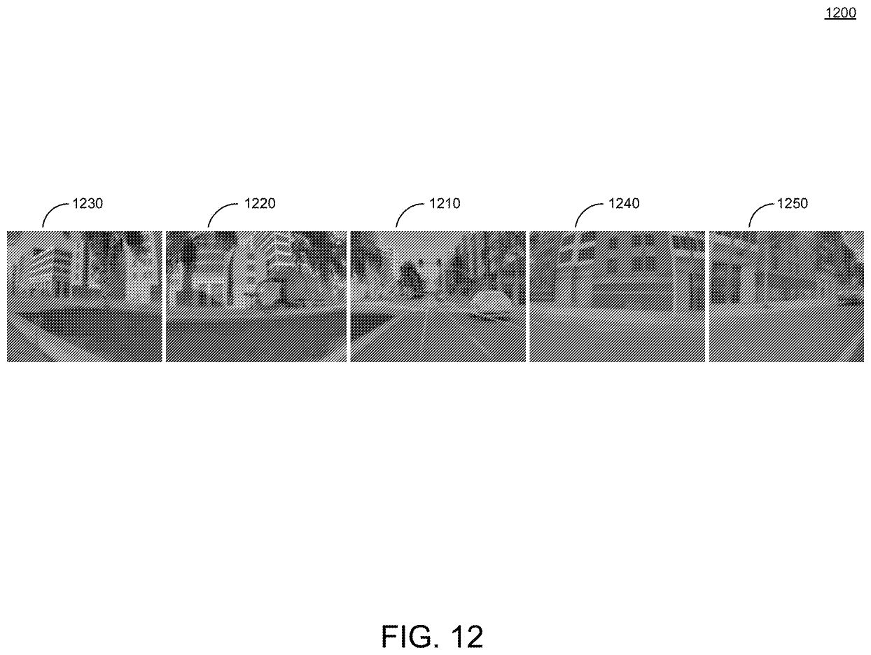

FIG. 12 depicts an example rendered video objects according to this disclosure. As illustrated by way of example in FIG. 12, a rendered video objects 1200 can include at least a front view video object 1210, a right-front view video object 1220, a right-rear view video object 1230, a left-front view video object 1240, and a left-rear view video object 1250. Each of the video objects 1210, 1220, 1230, 1240, and 1250 can correspond to 2D images or 2D video captured by a simulated ego vehicle 140 traveling through one or more of the environments 900B, 1000, 1100A or 1100B. The front view video object 1210 can correspond to 2D images or 2D video captured by a simulated ego vehicle 140 from a first simulated viewpoint oriented at and facing away from a front of the simulated ego vehicle 140. The right-front view video object 1220 can correspond to 2D images or 2D video captured by a simulated ego vehicle 140 from a second simulated viewpoint oriented at and facing away from a right-front of the simulated ego vehicle 140. The right-rear view video object 1230 can correspond to 2D images or 2D video captured by a simulated ego vehicle 140 from a third simulated viewpoint oriented at and facing away from a right-rear of the simulated ego vehicle 140. The left-front view video object 1240 can correspond to 2D images or 2D video captured by a simulated ego vehicle 140 from a fourth simulated viewpoint oriented at and facing away from a left-front of the simulated ego vehicle 140. The left-rear view video object 1250 can correspond to 2D images or 2D video captured by a simulated ego vehicle 140 from a fifth simulated viewpoint oriented at and facing away from a left-rear of the simulated ego vehicle 140.

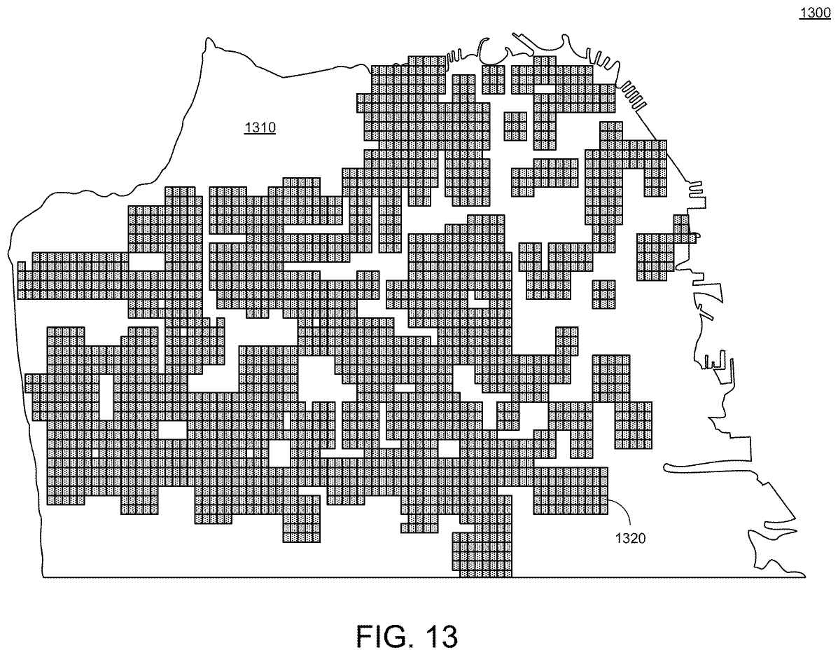

FIG. 13 depicts an example segmented geography model according to this disclosure. As illustrated by way of example in FIG. 13, a segmented geography model 1300 can include at least a geography region model 1310. The geography region model 1310 can correspond to a geographic region that indicates a physical area. For example, the geography region model 1310 can correspond to a physical region for San Francisco, CA. The geography region model 1310 can be linked with, define, or include, for example, one or more ground truth models 310 and one or more geospatial models 320 corresponding to a plurality of physical locations of the geographic region. The geography region model 1310 can include region segments 1320. The region segments 1320 can each correspond to respective portions of the geography region model 1310. For example, a size of each of the region segments 1320 can be determined according to the amount or type of computational resources required to render a 3D model based on the ground truth models 310 and one or more geospatial models 320 with each region segment among the region segments 1320. For example, one or more of the region segments 1320 can be set to a size including a physical area including ground truth models 310 and one or more geospatial models 320 that can be allocated within a computational limit of each processor or processor core of a multiprocessor system. The multiprocessor system can correspond to any computer environment as discussed herein.

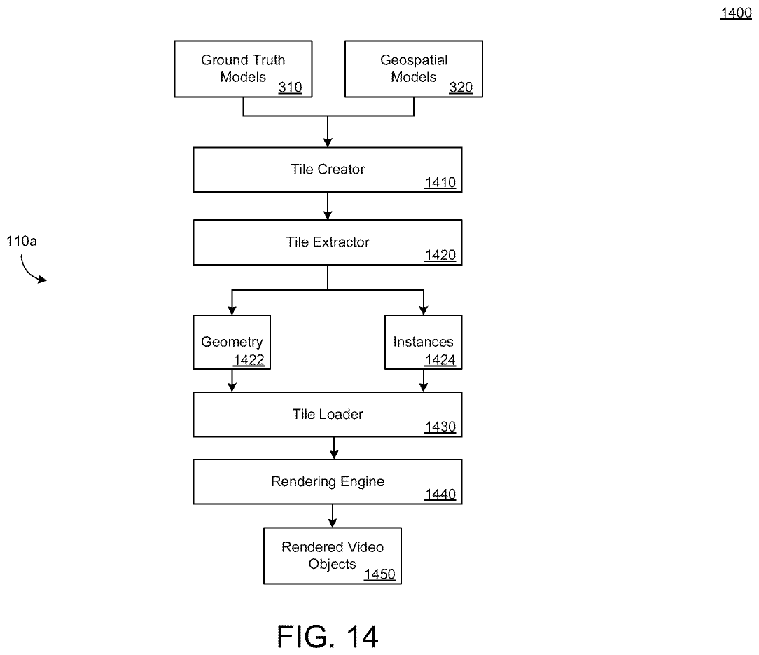

FIG. 14 depicts an example segmentation architecture according to this disclosure. As illustrated by way of example in FIG. 14, a segmentation architecture 1400 can include at least a tile creator 1410, a tile extractor 1420, a tile loader 1430, a rendering engine 1440, and one or more rendered video objects 1450, and can obtain one or more models among ground truth models 1402 and geospatial models 1404. The ground truth models 1402 can correspond at least partially in one or more of structure and operation to the ground truth models 310. The geospatial models 1404 can correspond at least partially in one or more of structure and operation to the geospatial models 320.

The tile creator 1410 can determine sizes of one or more tiles according to at least one of the ground truth models 310 and the geospatial models 320. For example, the tile creator 1410 can identify an amount of computing resources required to render one or more portions of the geography region model 1310 according to the ground truth models 310 and the geospatial models 320 associated with each of those portions. The tile creator 1410 can then generate region segments 1320 according to the determined sizes, according to a computational limit of each processor or processor core of the multiprocessor system.

The tile extractor 1420 can identify models corresponding to each of the region segments 1320. For example, the tile extractor 1420 can identify portions of the ground truth models 310 and the geospatial models 320 with coordinates located within respective boundaries of each of the region segments 1320. The tile extractor 1420 can include a model geometry 1422, and model instances 1424. The model geometry 1422 can correspond to portions of the ground truth models 310 and the geospatial models 320 indicative of the physical location of the real world. For example, the model geometry 1422 can correspond to one or more of the models 410, 420, 430 and 440. The model instances 1424 can correspond to portions of the ground truth models 310 and the geospatial models 320 indicative of objects in the physical location of the real world. For example, the model instances 1424 can correspond to one or more of the models indicative of 350 and 360.

The tile loader 1430 can allocate, to corresponding processors or processor cores, the portions of the of the ground truth models 310 and the geospatial models 320 indicative of the physical location of the real world. For example, the tile loader 1430 can identify a processor core having a computational limit that corresponds to or is greater than a computational requirement for a corresponding portion among the portions. The rendering engine 1440 can transform one or more of the region segments 1320 into one or more corresponding 3D models. The rendering engine can, for example, generate the region segments 1320 in accordance with the environments 400-100B as discussed herein.

In an example of operation, the embodiments herein may be used for a training scenario. For example, a system can obtain one or more models generated from measurement of boundaries of various roads, medians, crosswalks, sidewalks, bike lanes, or any other features of an outdoor built environment. The system can obtain information generated from measurement either from traveling through the roadways (e.g., with vehicles equipped with cameras, radar, lidar, or any combination) or by detect aspects of the roadway or surrounding environment externally (e.g., by satellite imagery or geospatial databases for an area). The system can apply the measurements to generate a model of a given intersection at a given city block. The system can add textures and objects to the roadway and the surrounding spaces to generate a visualization of the intersection as it appears in the real world. The system can include traffic pattern paths that control motion of vehicles, pedestrians, and other simulated roadway objects through the intersection. The system can change, remove or add street signs, road surfaces, street markings, weather conditions, road obstructions, traffic markers, or any combination thereof, to create multitudes of variations of the intersection, while maintaining the measured properties of the intersection as it appears in the real world. This way, the system can provide at least a technical improvement to provide a multitude of variation of a real world location to provide training data that far exceeds the volume and type that can be obtained by manual processes in the real world, including at least because many of the environments that can be generated by this technical solution do not and cannot exist in the real world. For example, an intersection cannot exist in the real world having a two-way traffic pattern and a one-way traffic pattern on the same roadway. However, this technical solution can create training data that matches both of these traffic configurations.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein. Directional indicators depicted herein are example directions to facilitate understanding of the examples discussed herein, and are not limited to the directional indicators depicted herein.

Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

Scope of the systems and methods described herein is thus indicated by the appended claims, rather than the foregoing description. The scope of the claims includes equivalents to the meaning and scope of the appended claims.

What is claimed is:

1. A system, comprising:
a non-transitory memory and one or more processors configured to:
retrieve a camera feed of an ego object navigating within a physical environment;
generate, according to one or more first environment metrics based on the camera feed, a three-dimensional (3D) model including a first surface corresponding to one or more physical ways through the physical environment, the one or more first environment metrics indicative of boundaries of the one or more physical ways;
generate, according to one or more second environment metrics, one or more geometric two-dimensional (2D) objects on the first surface, the second environment metrics indicative of the one or more physical ways;
identify, according to one or more viewpoint metrics indicative of cameras of a physical object configured to move along the one or more physical ways, one or more viewpoints oriented to capture corresponding portions of the 3D model;
render, from the one or more corresponding portions of the 3D model of the physical environment, one or more simulated environment 2D images each corresponding to respective ones of the viewpoints; and
training, by the processor, an artificial intelligence model in accordance with the camera feed and the one or more simulated environment 2D images.

2. The system of claim 1, the processors to:
modify, according to one or more third environment metrics, a portion of the first surface corresponding to a portion of a physical way among the physical ways, the one or more third environment metrics indicative of a condition of the physical way.

3. The system of claim 1, the processors to:
modify, according to one or more third environment metrics, a topology of the portion of the first surface.

4. The system of claim 1, the processors to:
modify, according to one or more third environment metrics, an opacity of at least a portion of a geometric 2D object among the geometric 2D objects, the geometric 2D object located at the portion of the first surface.

5. The system of claim 1, the processors to:
generate, according to a localization heuristic indicative of a type of physical objects in the physical environment, one or more 3D objects that satisfy the localization heuristic at one or more corresponding positions in a second surface of the 3D model excluding the first surface.

6. The system of claim 5, the type of physical objects corresponding to at least one of a type of geography, a type of climate, or a type of architecture.

7. The system of claim 1, the processors to:
generate, according to an environment heuristic indicative of an atmospheric condition, indicative of weather in the physical environment, one or more 3D objects that satisfy the environment heuristic at one or more corresponding positions in the 3D model.

8. The system of claim 1, the processors to:
segment, according to a block heuristic indicative of an amount of computational resources, a region model into a plurality of region segments, the region model indicative of a physical region including the physical environment, and the region segments each corresponding to a respective portion of the region model, the 3D model corresponding to a region segment among the region segments.

9. The system of claim 8, the processors to:
execute, by a first computation resource, a first subset of the region segments; and
execute, by a second computation resource and concurrently with the execution by the first computation resource, a second subset of the region segments.

10. A method, comprising:
retrieving, by a processor, a camera feed of an ego object navigating within a physical environment;
generating, by the processor according to one or more first environment metrics based on the camera feed, a three-dimensional (3D) model including a first surface corresponding to one or more physical ways through the physical environment, the one or more first environment metrics indicative of boundaries of the one or more physical ways;
generating, by the processor according to one or more second environment metrics, one or more geometric two-dimensional (2D) objects on the first surface, the second environment metrics indicative of the one or more physical ways;
identifying, by the processor according to one or more viewpoint metrics indicative of cameras of a physical object configured to move along the one or more physical ways, one or more viewpoints oriented to capture corresponding portions of the 3D model;
rendering, by the processor, from the one or more corresponding portions of the 3D model of the physical environment, one or more simulated environment 2D images each corresponding to respective ones of the viewpoints; and
training, by the processor, an artificial intelligence model in accordance with the camera feed and the one or more simulated environment 2D images.

11. The method of claim 10, further comprising:
modifying, according to one or more third environment metrics, a portion of the first surface corresponding to a portion of a physical way among the physical ways, the one or more third environment metrics indicative of a condition of the physical way.

12. The method of claim 10, further comprising:
modifying, according to one or more third environment metrics, a topology of the portion of the first surface.

13. The method of claim 10, further comprising:
modifying, according to one or more third environment metrics, an opacity of at least a portion of a geometric 2D object among the geometric 2D objects, the geometric 2D object located at the portion of the first surface.

14. The method of claim 10, further comprising:
generating, according to a localization heuristic indicative of a type of physical objects in the physical environment, one or more 3D objects that satisfy the localization heuristic at one or more corresponding positions in a second surface of the 3D model excluding the first surface.

15. The method of claim 14, the type of physical objects corresponding to at least one of a type of geography, a type of climate, or a type of architecture.

16. The method of claim 10, further comprising:
generating, according to an environment heuristic indicative of an atmospheric condition, indicative of weather in the physical environment, one or more 3D objects that satisfy the environment heuristic at one or more corresponding positions in the 3D model.

17. The method of claim 10, further comprising:
segmenting, according to a block heuristic indicative of an amount of computational resources, a region model into a plurality of region segments, the region model indicative of a physical region including the physical environment, and the region segments each corresponding to a respective portion of the region model, the 3D model corresponding to a region segment among the region segments.

18. The method of claim 17, further comprising:
executing, by a first computation resource, a first subset of the region segments; and
execute, by a second computation resource and concurrently with the execution by the first computation resource, a second subset of the region segments.

19. A non-transitory computer readable medium including one or more instructions stored thereon and executable by a processor to:
retrieve, by a processor, a camera feed of an ego object navigating within a physical environment;
generate, by the processor and according to one or more first environment metrics based on the camera feed, a three-dimensional (3D) model including a first surface corresponding to one or more physical ways through the physical environment, the one or more first environment metrics indicative of boundaries of the one or more physical ways;
generate, by the processor and according to one or more second environment metrics, one or more geometric two-dimensional (2D) objects on the first surface, the second environment metrics indicative of the one or more physical ways;
identify, by the processor and according to one or more viewpoint metrics indicative of cameras of a physical object configured to move along the one or more physical ways, one or more viewpoints oriented to capture corresponding portions of the 3D model;
render, by the processor and from the one or more corresponding portions of the 3D model of the physical environment, one or more simulated environment 2D images each corresponding to respective ones of the viewpoints; and
training, by the processor, an artificial intelligence model in accordance with the camera feed and the one or more simulated environment 2D images.

20. The computer readable medium of claim 19, the computer readable medium further including one or more instructions executable by the processor to:
modify, according to one or more third environment metrics, a portion of the first surface corresponding to a portion of a physical way among the physical ways, the one or more third environment metrics indicative of a condition of the physical way.
